(19) United States
(12) Patent Application Publication
(10) Pub. No.: US 2014/0290473 A1
(43) Pub. Date: Oct. 2, 2014

(54) POLYCARBONATE LAMINATE FOR CLOSE-PROXIMITY BLAST EVENTS

(71) Applicants: James M. Lorenzo, Mars, PA (US); Robert A. Pyles, Bethel Park, PA (US)

(72) Inventors: James M. Lorenzo, Mars, PA (US); Robert A. Pyles, Bethel Park, PA (US)

(73) Assignee: Bayer MaterialScience LLC, Pittsburg, PA (US)

(21) Appl. No.: 14/126,891

(22) PCT Filed: Jun. 20, 2012
(86) PCT No.: PCT/US12/43262

§ 371 Date: May 22, 2014

(30) Foreign Application Priority Data
Jun. 21, 2011 (US) 61499256

(51) Int. Cl. F41H 5/04; B32B 27/08

(52) U.S. Cl. CPC F41H 5/04; B32B 27/08; B32B 2250/40; B32B 2307/558; B32B 2571/02
USPC 89/36.02; 428/412; 428/220

(57) ABSTRACT

The present invention provides a laminate for protecting an object against close-proximity blasts, ballistic and severe storm events, the laminate comprising two or more layers of polycarbonate having layered there between one or more layers of a thermoplastic polyurethane. Also provided is a method of protecting an object from a close-proximity blasts, ballistic and severe storm events, the method comprising placing between the object and the close-proximity blast, ballistic or severe storm event, the inventive laminate. The inventive laminate can afford increased protection to an object against 50 lbs. to 100 lbs. of trinitrotoluene-equivalent from distances as close as about 3 feet (0.91 m).

### RELATED APPLICATION

The present invention is a non-provisional application of provisional application 61/499,256 filed Jun. 21, 2011, the entirety of which is incorporated by reference herein.

### FIELD OF THE INVENTION

The present invention relates in general to blast and ballistic protection and more specifically to a polycarbonate laminate useful for protection against close-proximity blast, ballistic and severe storm events.

### BACKGROUND OF THE INVENTION

Ahmad, in U.S. Pat. No. 7,562,613, provides a protective structure for protecting buildings, bridges, roads and other areas from explosive devices such as car bombs and the like made of: (a) a mesh structure having an outer surface and an inner surface, wherein the inner surface defines an annular space; (b) a plurality of structural steel cables in contact with the mesh structure; (c) composite fill material which resides within the annular space of the mesh structure and within the mesh structure; (d) at least one reinforcement member which resides within the composite fill material; and (e) a composite face material which resides upon the outer surface of the mesh structure. The mesh structure may be made up of, for example, steel wire. The described protective system for protecting buildings, bridges, roads and other areas from explosive devices such as car bombs etc. may be made from a plurality of the described protective structures and a plurality of support members, wherein the support members provide interlocking engagement of the protective structures to the support members.

U.S. Pat. No. 8,011,146, issued to Krause describes a blast-proof window and mullion system for sustaining and mitigating an explosion and/or blast to the window and mullion system on a multi-storied building or structure. The window and mullion system is detailed as including a blast-resistant mullion having a mullion housing with mullion walls with outer surfaces; and a pressure bar member having a pressure bar housing with an interior wall and a pair of outer walls being connected to the interior wall to form a center channel opening. The outer walls are said to be angled for reducing the space between the angled walls and for reducing the size of the center channel opening for reduction of bullet and/or blast penetration to the interior wall of the pressure bar member. Also, one of the mullion walls of the mullion housing is said to include a mullion tongue thereon having a pair of tongue extension arms for forming a vertical bolt receiving channel there between. Each of the tongue extension arms has interior serrated surfaces for receiving threaded bolts between the interior serrated surfaces. The interior wall of the pressure bar member has a pair of spaced-apart pressure bar extension arms thereon. The interior wall of the pressure bar member includes a plurality of spaced-apart bolt openings for receiving a plurality of the threaded bolts therein for permanently locking together the pressure bar extension arms with the mullion extension arms in order to join together and lock the pressure bar housing of the pressure bar member to said mullion housing of the blast-resistant mullion to form the blast-proof window and mullion system.

A need continues to exist in the art for improved protective systems for close-proximity blast, ballistic and severe storm events.

### SUMMARY OF THE INVENTION

Accordingly, the present invention provides such improved protective systems for close-proximity blast, ballistic and severe storm events. The improved protective systems comprise a polycarbonate laminate that can protect an object against 50 lbs. to 100 lbs. of trinitrotoluene-equivalent from distances as close as about 3 feet (0.91 m). The improved polycarbonate laminate of the present invention comprises polycarbonate layers laminated with one or more thermoplastic polyurethane (“TPU”) interlayers to achieve a final laminate thickness in the range of about 4 inches (10.2 cm) to about 6 inches (15.2 cm). The inventive protective systems can be used either directly against a concrete wall (depending on construction) or optionally with an about 2 feet (0.61 m) to about 4 feet (1.22 m) air gap standoff from building. The inventive laminate and protective systems made with it can provide improved protection from close-proximity blast, ballistic events and severe storm events, such as hurricanes, cyclones, typhoons and tornados.

These and other advantages and benefits of the present invention will be apparent from the Detailed Description of the Invention herein below.

### BRIEF DESCRIPTION OF THE FIGURES

The present invention will now be described for purposes of illustration and not limitation in conjunction with the figures, wherein:

FIGS. 1A and 1B show a model blast protective system;

FIG. 2 shows the target point for a blast or ballistic event on a model blast protective system;

FIG. 3 illustrates the standoff distance from the blast event to the target;

FIGS. 4A-4D show the predicted damage for a 3 inch (7.62 cm) nominal polycarbonate sheet laminate having one thermoplastic polyurethane layer between the polycarbonate sheets using 100 lbs. (45.4 kg) of trinitrotoluene-equivalent detonated at a distance of one foot (0.305 m);

FIGS. 5A-5D shows the predicted damage for a 4.5 inch (11.4 cm) nominal polycarbonate sheet laminate having one thermoplastic polyurethane layer between the each of the polycarbonate sheets using 50 lbs. (22.7 kg) of trinitrotoluene-equivalent detonated at a distance of five feet (1.52 m);

FIGS. 6A and 6B illustrate a laminate and concrete wall quarter-symmetry model;

FIGS. 7A and 7B provide a comparison of subjecting an 18 inch (0.475 m) unreinforced concrete wall to a simulated 50 lbs. (22.7 kg) of trinitrotoluene-equivalent detonated at a distance of five feet (1.52 m), with FIG. 7A showing an unprotected wall and FIG. 7B showing a wall protected by the inventive laminate and a 24 inch (0.61 m) air gap;

FIGS. 8A-8F illustrate the deflection prediction for the wall protected by a three polycarbonate sheet laminate having one thermoplastic polyurethane layer between the each of the polycarbonate sheets, and a 24 inch (0.61 m) air gap;

FIGS. 9A-9F illustrate the air gap pressure for a wall protected by a three polycarbonate sheet laminate having one thermoplastic polyurethane layer between the each of the polycarbonate sheets, and a 24 inch (0.61 m) air gap;

FIGS. 10A-10H illustrate the concrete wall strain for a walls that are subjected to a simulated 50 lbs. (22.7 kg) of trinitrotoluene-equivalent detonated at a distance of five feet (1.52 m);

FIGS. 11A-11F illustrate subjecting an 18 inch (0.475 m) unreinforced concrete wall to a simulated 50 lbs. (22.7 kg) of trinitrotoluene-equivalent detonated at a distance of 4 feet (1.22 m), with the wall protected by a three polycarbonate sheet laminate having one thermoplastic polyurethane layer between the each of the polycarbonate sheets, and a 24 inch (0.61 m) air gap;

FIGS. 12A-12F illustrate the air gap pressure for the wall protected by the laminate as shown in FIGS. 11A-11F;

FIGS. 13A-13D illustrate the concrete wail strain for an 18 inch (0.475 m) unreinforced concrete wall that is subjected to a simulated 50 lbs. (22.7 kg) of trinitrotoluene-equivalent detonated at a distance of 4 feet (1.22 m), with the wall protected by a three polycarbonate sheet laminate having one thermoplastic polyurethane layer between the each of the polycarbonate sheets, and a 24 inch (0.61 m) air gap.

FIGS. 14A-14F show the deflection prediction of subjecting an 18 inch (0.475 m) unreinforced concrete wall to a simulated 50 lbs. (22.7 kg) of trinitrotoluene-equivalent detonated at a distance of three feet (0.914 m), with the wall protected by a three polycarbonate sheet laminate having one thermoplastic polyurethane layer between the each of the polycarbonate sheets and no air gap.

### DETAILED DESCRIPTION OF THE INVENTION

The present invention will now be described for purposes of illustration and not limitation. Except in the operating examples, or where otherwise indicated, all numbers expressing quantities, percentages, OH numbers, functionalities and so forth in the specification are to be understood as being modified in all instances by the term “about.” Equivalent weights and molecular weights given herein in Daltons (Da) are number average equivalent weights and number average molecular weights respectively, unless indicated otherwise.

The present invention provides a laminate for protecting an object against one of a close-proximity blast, a ballistic event and a severe storm event, the laminate comprising two or more layers of polycarbonate having layered therebetween one or more layers of a thermoplastic polyurethane.

The present invention further provides a protective system for one of a close-proximity blast, a ballistic event and a severe storm event, the system comprising a laminate comprising two or more layers of polycarbonate having layered therebetween one or more layers of a thermoplastic polyurethane.

The present invention yet further provides a method for protecting an object from one of a close-proximity blast, a ballistic event and a severe storm event, the method involving placing between the object and the blast, ballistic and storm event, a laminate comprising two or more layers of polycarbonate having layered therebetween one or more layers of a thermoplastic polyurethane.

The present invention still further provides a method of protecting an object against 50 lbs. (22.7 kg) to 100 lbs. (45.4 kg) of trinitrotoluene-equivalent detonated at a distance of about 3 feet (0.914 m), the method involving placing between the object and the 50 lbs. to 100 lbs. of trinitrotoluene-equivalent, a laminate comprising two or more layers of polycarbonate having layered there between one or more layers of a thermoplastic polyurethane.

Suitable polycarbonate resins for preparing the laminates of the present invention are homopolycarbonates and copolycarbonates, both linear or branched resins and mixtures thereof.

The polycarbonates have a weight average molecular weight of preferably 10,000 to 200,000, more preferably 20,000 to 80,000 and their melt flow rate, per ASTM D-1238 at 300° C., is preferably 1 to 65 g/10 min., more preferably 2 to 35 g/10 min. They may be prepared, for example, by the known diphasic interface process from a carbonic acid derivative such as phosgene and dihydroxy compounds by polycondensation (See, German Offenlegungssehriften 2,063,050; 2,063,052; 1,570,703; 2,211,956; 2,211,957 and 2,248,817; French Patent 1,561,518; and the monograph by H. Schnell, “Chemistry and Physics of Polycarbonates”, Interscience Publishers, New York, N.Y., 1964).

In the present context, dihydroxy compounds suitable for the preparation of the polycarbonates of the invention conform to the structural formulae (1) or (2) below.

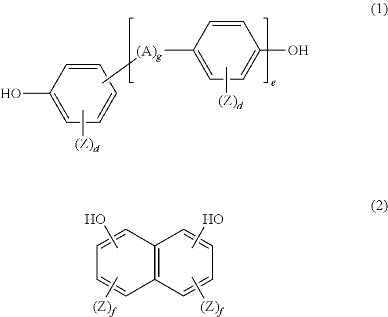

wherein
A denotes an alkylene group with 1 to 8 carbon atoms, an alkylidene group with 2 to 8 carbon atoms, a cycloalkylene group with 5 to 15 carbon atoms, a cycloalkylidene group with 5 to 15 carbon atoms, a carbonyl group, an oxygen atom, a sulfur atom, —SO— or —SO₂ or a radical conforming to

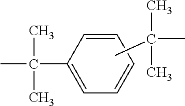

e and g both denote the number 0 to 1;
Z denotes F, Cl, Br or C₁-C₄-alkyl and if several Z radicals are substituents in one aryl radical, they may be identical or different from one another;
d denotes an integer of from 0 to 4; and
f denotes an integer of from 0 to 3.

Among the dihydroxy compounds useful in the practice of the invention are hydroquinone, resorcinol, bis-(hydroxyphenyl)-alkanes, bis-(7droxyl-phenyl)-ethers, bis-(hydroxyphenyl)-ketones, bis-(7ydroxyl-phenyl)-sulfoxides, bis-(hydroxyphenyl)-sulfides, bis-(hydroxyphenyl)-sulfones, and α,α-bis-(hydroxyphenyl)-diisopropylbenzenes, as well as their nuclear-alkylated compounds. These and further suitable aromatic dihydroxy compounds are described, for example, in U.S. Pat. Nos. 5,401,826, 5,105,004; 5,126,428; 5,109,076; 5,104,723; 5,086,157; 3,028,356; 2,999,835; 3,148,172; 2,991,273; 3,271,367; and 2,999,846, the contents of which are incorporated herein by reference.

Further examples of suitable bisphenols are 2,2-bis-(4-hydroxyphenyl)-propane (bisphenol A), 2,4-bis-(4-hydroxyphenyl)-2-methyl-butane, 1,1-bis-(4-hydroxyphenyl)-cyclohexane, α,α′-bis-(4-hydroxy-phenyl)-p-diisopropylbenzene, 2,2-bis-(3-methyl-4-hydroxyphenyl)-propane, 2,2-bis-(3-chloro-4-hydroxyphenyl)-propane, 4,4′-dihydroxy-diphenyl, bis-(3,5-dimethyl-4-hydroxyphenyl)-methane, 2,2-bis-(3,5-dimethyl-4-hydroxyphenyl)-propane, bis-(3,5-dimethyl-4-hydroxyphenyl)-sulfide, bis-(3,5-dimethyl-4-hydroxy-phenyl)-sulfoxide, bis-(3,5-dimethyl-4-hydroxyphenyl)-sulfone, dihydroxy-benzophenone, 2,4-bis-(3,5-dimethyl-4-hydroxyphenyl)-cyclohexane, α,α′-bis-(3,5-dimethyl-4-hydroxyphenyl)-p-diisopropyl-benzene and 4,4′-sulfonyl diphenol.

Examples of particularly preferred aromatic bisphenols are 2,2-bis-(4-hydroxyphenyl)-propane, 2,2-bis-(3,5-dimethyl-4-hydroxyphenyl)-propane, 1,1-bis-(4-hydroxyphenyl)-cyclohexane and 1,1-bis-(4-hydroxy-phenyl)-3,3,5-trimethylcyclohexane. The most preferred bisphenol is 2,2-bis(4-hydroxyphenyl)-propane (bisphenol A).

The polycarbonates useful in producing the sheets for the laminates of the invention may entail in their structure units derived from one or more of the suitable bisphenols.

Among the resins suitable in the practice of the invention are phenolphthalein-based polycarbonate, copolycarbonates and terpolycarbonates such as are described in U.S. Pat. Nos. 3,036,036 and 4,210,741, both of which are incorporated by reference herein.

The polycarbonates useful in preparing the sheets laminates of the invention may also be branched by condensing therein small quantities, e.g., 0.05 to 2.0 mol % (relative to the bisphenols) of polyhydroxyl compounds. Polycarbonates of this type have been described, for example, in German Offenlegungsschriften 1,570,533; 2,116,974 and 2,113,374; British Patents 885,442 and 1,079,821 and U.S. Pat. No, 3,544,514, which is incorporated herein by reference. The following are some examples of polyhydroxyl compounds which may be used for this purpose: phloroglucinol; 4,6-dimethyl-2,4,6-tri-(4-hydroxy-phenyl)-heptane; 1,3,5-tri-(4-hydroxyphenyl)-benzene; 1,1,1-tri-(4-hydroxyphenyl)-ethane; tri-(4-hydroxyphenyl)-phenyl-methane; 2,2-bis-[4,4-(4,4′-dihydroxydiphenyl)]-cyclohexyl-propane; 2,4-bis-(4-hydroxy-1-isopropylidine)-phenol; 2,6-bis-(2′-dihydroxy-5′-methylbenzyl)-4-methyl-phenol; 2,4-dihydroxybenzoic acid; 2-(4-hydroxy-phenyl)-2-(2,4-dihydroxy-phenyl)-propane and 1,4-bis-(4,4′-dihydroxytri-phenylmethyl)-benzene. Some of the other polyfunctional compounds are 2,4-dihydroxy-benzoic acid, trimesic acid, cyanuric chloride and 3,3-bis-(4-hydroxyphenyl)-2-oxo-2,3-dihydroindole.

In addition to the polycondensation process mentioned above, other processes for the preparation of the polycarbonates of the invention are polycondensation in a homogeneous phase and transesterification. The suitable processes are disclosed in U.S. Pat. Nos. 3,028,365; 2,999,846; 3,153,008; and 2,991,273 which are incorporated herein by reference.

The preferred process for the preparation of polycarbonates is the interfacial polycondensation process. Other methods of synthesis in forming the polycarbonates of the invention, such as disclosed in U.S. Pat. No. 3,912,688, incorporated herein by reference, may be used. Suitable polycarbonate materials are available in commerce, for instance, from Bayer MaterialScience under the MAKROLON and HYGARD trademarks. The polycarbonate is preferably used in the form of sheets or films in the inventive laminates.

Aliphatic thermoplastic polyurethanes are particularly preferred in the laminates of the present invention such as those prepared according to U.S. Pat. No. 6,518,389, the entire contents of which are incorporated herein by reference.

Thermoplastic polyurethane elastomers are well known to those skilled in the art. They are of commercial importance due to their combination of high-grade mechanical properties with the known advantages of cost-effective thermoplastic processability. A wide range of variation in their mechanical properties can be achieved by the use of different chemical synthesis components. A review of thermoplastic polyurethanes, their properties and applications is given in Kunststoffe [Plastics] 68 (1978), pages 819 to 825, and in Kautschuk, Gummi, Kunststoffe [Natural and Vulcanized Rubber and Plastics] 35 (1982), pages 568 to 584.

Thermoplastic polyurethanes are synthesized from linear polyols, mainly polyester diols or polyether diols, organic diisocyanates and short chain diols (chain extenders). Catalysts may be added to the reaction to speed up the reaction of the components.

The relative amounts of the components may be varied over a wide range of molar ratios in order to adjust the properties. Molar ratios of polyols to chain extenders from 1:1 to 1:12 have been reported. These result in products with hardness values ranging from 80 Shore A to 75 Shore D.

Thermoplastic polyurethanes can be produced either in stages (prepolymer method) or by the simultaneous reaction of all the components in one step (one shot). In the former, a prepolymer formed from the polyol and diisocyanate is first formed and then reacted with the chain extender. Thermoplastic polyurethanes may be produced continuously or batch-wise. The best-known industrial production processes are the so-called belt process and the extruder process.

Examples of the suitable polyols include difunctional polyether polyols, polyester polyols, and polycarbonate polyols. Small amounts of trifunctional polyols may be used, yet care must be taken to make certain that the thermoplasticity of the thermoplastic polyurethane remains substantially un-effected.

Suitable polyester polyols include those which are prepared by polymerizing ε-caprolactone using an initiator such as ethylene glycol, ethanolamine and the like. Further suitable examples are those prepared by esterification of polycarboxylic acids. The polycarboxylic acids may be aliphatic, cycloaliphatic, aromatic and/or heterocyclic and they may be substituted, e.g., by halogen atoms, and/or unsaturated. The following are mentioned as examples: succinic acid; adipic acid; suberic acid; azelaic acid; sebacic acid; phthalic acid; isophthalic acid; trimellitic acid; phthalic acid anhydride; tetrahydrophthalic acid anhydride; hexahydrophthalic acid anhydride; tetrachlorophthalic acid anhydride, endomethylene tetrahydrophthalic acid anhydride; glutaric acid anhydride; maleic acid; maleic acid anhydride; fumaric acid; dimeric and trimeric fatty acids such as oleic acid, which may be mixed with monomeric fatty acids; dimethyl terephthalates and bis-glycol terephthalate. Suitable polyhydric alcohols include, e.g., ethylene glycol; propylene glycol-(1,2) and -(1,3); butylene glycol-(1,4) and -(1,3); hexanediol-(1,6); octanediol-(1,8); neopentyl glycol; (1,4-bis-hydroxy-methylcyclohexane); 2-methyl-1,3-propanediol; 2,2,4-tri-methyl-1,3-pentanediol; triethylene glycol; tetraethylene glycol; polyethylene glycol; dipropylene glycol; polypropylene glycol; dibutylene glycol and polybutylene glycol, glycerine and trimethlyolpropane.

Suitable polyisocyanates for producing the thermoplastic polyurethanes useful in the laminates of the present invention may be, for example, organic aliphatic diisocyanates including, for example, 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3- and -1,4-diisocyanate, 1-isocyanato-2-isocyanatomethyl cyclopentane, 1-isocyanato-3-isocyanatomethyl-3,5,5-trimethyl-cyclohexane (isophorone diisocyanate or IPDI), bis-(4-isocyanatocyclohexyl)-methane, 2,4′-dicyclohexylmethane diisocyanate, 1,3- and 1,4-bis-(isocyanatomethyl)-cyclohexane, bis-(4-isocyanato-3-methylcyclohexyl)-methane, α,α,α′,α′-tetramethyl-1,3- and/or -1,4-xylylene diisocyanate, 1-isocyanato-1-methyl-4(3)-isocyanatomethyl cyclohexane, 2,4- and/or 2,6-hexahydrotoluylene diisocyanate, and mixtures thereof.

Preferred chain extenders with molecular weights of 62 to 500 include aliphatic diols containing 2 to 14 carbon atoms, such as ethanediol, 1,6-hexanediol, diethylene glycol, dipropylene glycol, and 1,4-butanediol in particular, for example. However, diesters of terephthalic acid with glycols containing 2 to 4 carbon atoms are also suitable, such as terephthalic acid-bis-ethylene glycol or -1,4-butanediol for example, or hydroxyalkyl ethers of hydroquinone, such as 1,4-di-(β-hydroxyethyl)-hydroquinone for example, or (cyclo)aliphatic diamines, such as isophorone diamine, 1,2- and 1,3-propylenediamine, N-methyl-propylenediamine-1,3 or N,N′-dimethyl-ethylenediamine, for example, and aromatic diamines, such as toluene 2,4- and 2,6-diamines, 3,5-diethyltoluene 2,4- and/or 2,6-diamine, and primary ortho-, di-, tri- and/or tetraalkyl-substituted 4,4′-diaminodiphenylmethanes, for example. Mixtures of the aforementioned chain extenders may also be used. Optionally, triol chain extenders having a molecular weight of 62 to 500 may also be used. Moreover, customary monofunctional compounds may also be used in small amounts, e.g., as chain terminators or demolding agents. Alcohols such as octanol and stearyl alcohol or amines such as butylamine and stearylamine may be cited as examples.

To prepare the thermoplastic polyurethanes, the synthesis components may be reacted, optionally in the presence of catalysts, auxiliary agents and/or additives, in amounts such that the equivalent ratio of NCO groups to the sum of the groups which react with NCO, particularly the OH groups of the low molecular weight diols/triols and polyols, is 0.9:1.0 to 1.2:1.0, preferably 0.95:1.0 to 1.10:1.0.

Suitable catalysts include tertiary airlines which are known in the art, such as triethylamine, dimethyl-cyclohexylamine, N-methylmorpholine, N,N′-dimethyl-piperazine, 2-(dimethyl-aminoethoxy)-ethanol, diazabicyclo-(2,2,2)-octane and the like, for example, as well as organic metal compounds in particular, such as titanic acid esters, iron compounds, tin compounds, e.g., tin diacetate, tin dioctoate, tin dilaurate or the dialkyltin salts of aliphatic carboxylic acids such as dibutyltin diacetate, dibutyltin dilaurate or the like. The preferred catalysts are organic metal compounds, particularly titanic acid esters and iron and/or tin compounds.

In addition to difunctional chain extenders, small quantities of up to about 5 mol. Percent, based on moles of the bifunctional chain extender used, of trifunctional or more than trifunctional chain extenders may also be used.

Trifunctional or more than trifunctional chain extenders of the type in question are, for example, glycerol, trimethylolpropane, hexanetriol, pentaerythritol and triethanolamine.

Suitable thermoplastic polyurethanes are available in commerce, for example, from Bayer MaterialScience under the TEXIN trademark. The thermoplastic polyurethanes are preferably used in the present invention in the form of films or sheets.

The thickness of the laminate of the present invention is preferably 4 inches (10.2 cm) to 6 inches (15.2 cm), more preferably 4 inches (10.2 cm) to 5 inches (12.7 cm). The thickness of the laminate of the present invention may be in an amount ranging between any combination of these values, inclusive of the recited values. Optionally, the inventive laminate may be placed at a standoff of 2 feet (0.61 m) to 4 feet (1.22 m), more preferably 3 feet (0.91 m) to 4 feet (1.22 m) from the object (such as a building or other structure) to be protected to introduce an “air gap” between the laminate and the structure and thereby provide additional protection against the blast, ballistic or severe storm event. The standoff distance of the inventive laminate from the object to be protected may be in an amount ranging between any combination of these values, inclusive of the recited values. Although the laminate of the present invention is most often illustrated in the present disclosure as a three polycarbonate/two thermoplastic polyurethane material, those skilled in the art will recognize that any number and combination of layers is possible depending upon the level of protection desired.

### EXAMPLES

The present invention is further illustrated, but is not to be limited, by the following examples. The following materials were used in modeling the illustrated blast protective systems:

| | |
|---|---|
| POLYCARBONATE SHEETS | 4 foot × 8 foot |
| | (1.22 m × 2.44 m) sheets, |
| | commercially available from Bayer |
| | MaterialScience under the trademark |
| | MAKROLON; |
| TPU FILM | thermoplastic polyurethane film |
| | commercially available from Bayer |
| | MaterialScience under the trademark |
| | TEXIN. |

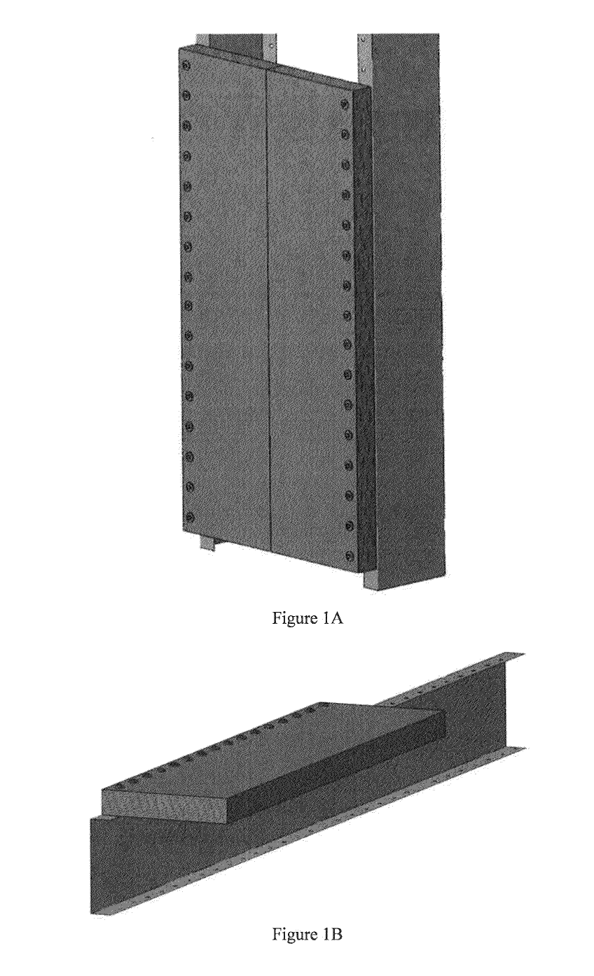

A blast protective system is shown in FIGS. 1A and 1B. Briefly, the system comprises two metal columns, laminated panel and attachment bolts (FIG. 1A). For simplicity, either a half-symmetry or quarter-symmetry model was used as shown in FIG. 1B. The laminates depicted in the present disclosure were solved with ABAQUS/Explicit (Acoustic incident wave approach for air-borne shock loading using a reflected pressure history profile) software commercially available from Dassualt Systemes Simulia Corp.

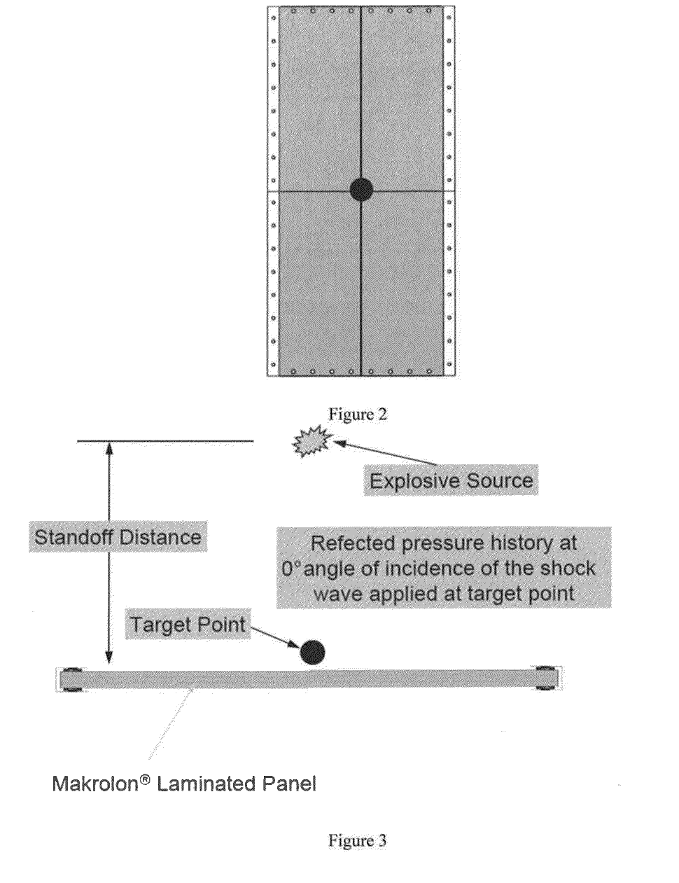

FIG. 2 shows the target point for a blast or ballistic event on a model blast protective system. The charge was located at the center of the panel.

FIG. 3 illustrates the standoff distance from the blast event to the target. As can be appreciated by reference to FIG. 3, the explosive source was located at the center of the panel and offset perpendicularly from the plane of the panel by various distances. A reflected pressure vs. time history was used as input for various charge size and standoff distance combinations.

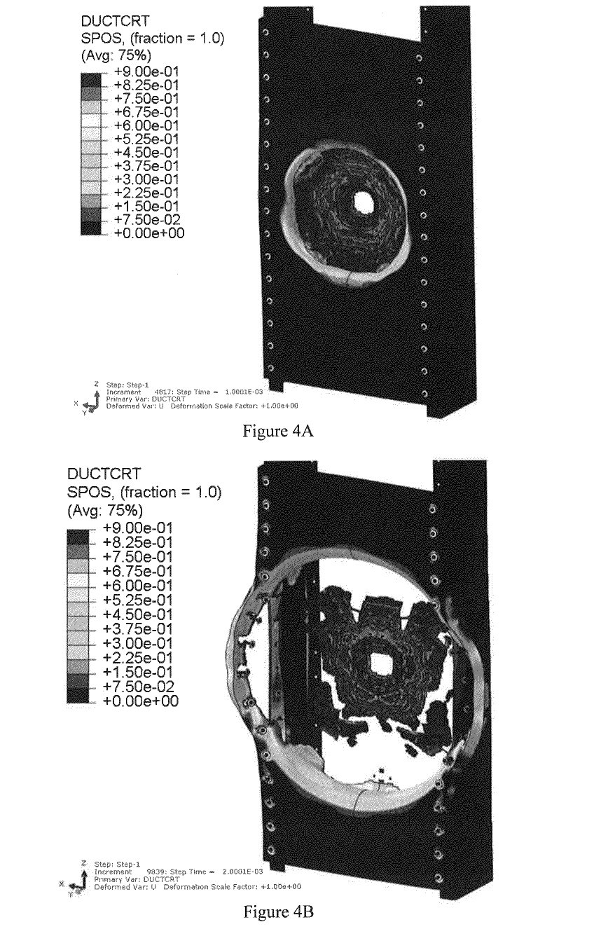

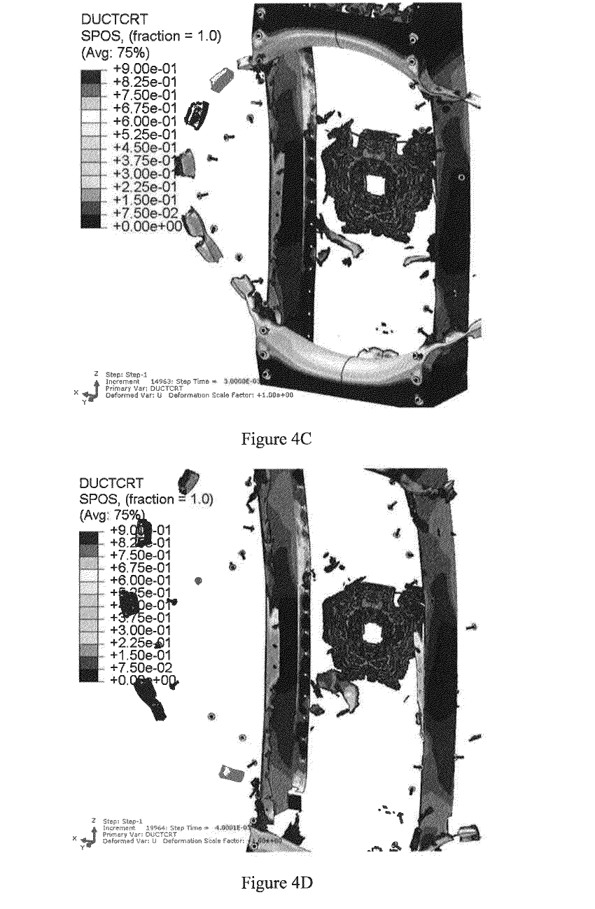

FIGS. 4A-4D show the predicted damage for a 3 inch (7.62 cm) nominal polycarbonate sheet laminate having one thermoplastic polyurethane layer between the polycarbonate sheets using 100 lbs. (45.4 kg) of trinitrotoluene-equivalent detonated at a distance of one foot (0.305 m) at one millisecond after the detonation (FIG. 4A), two milliseconds (FIG. 4B), three milliseconds (FIG. 4C) and four milliseconds (FIG. 4D). As can be appreciated by reference to FIGS. 4A-4D, the devastating effects of a near-proximity or contact charge require special counter-measures to protect against breach of the panel.

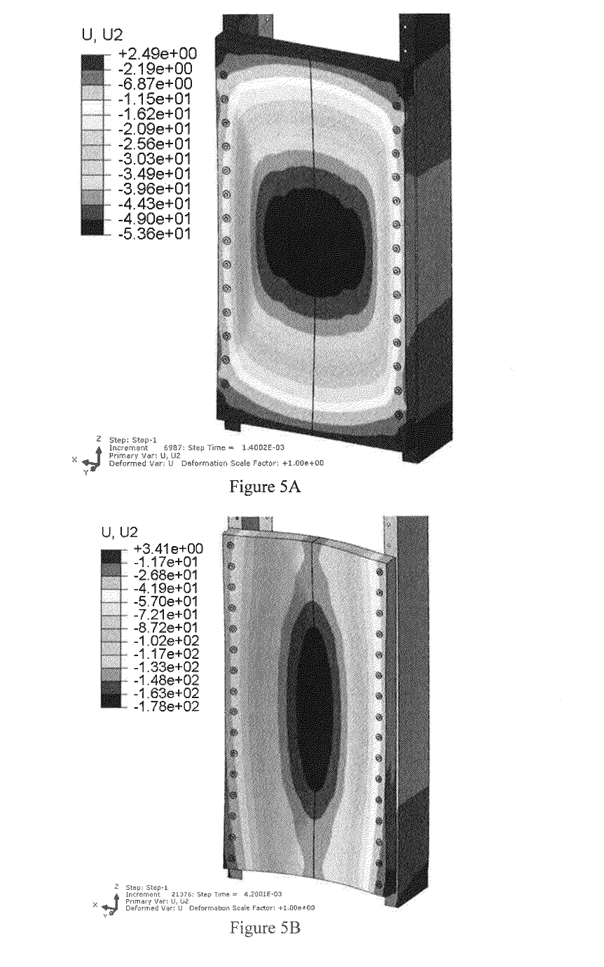

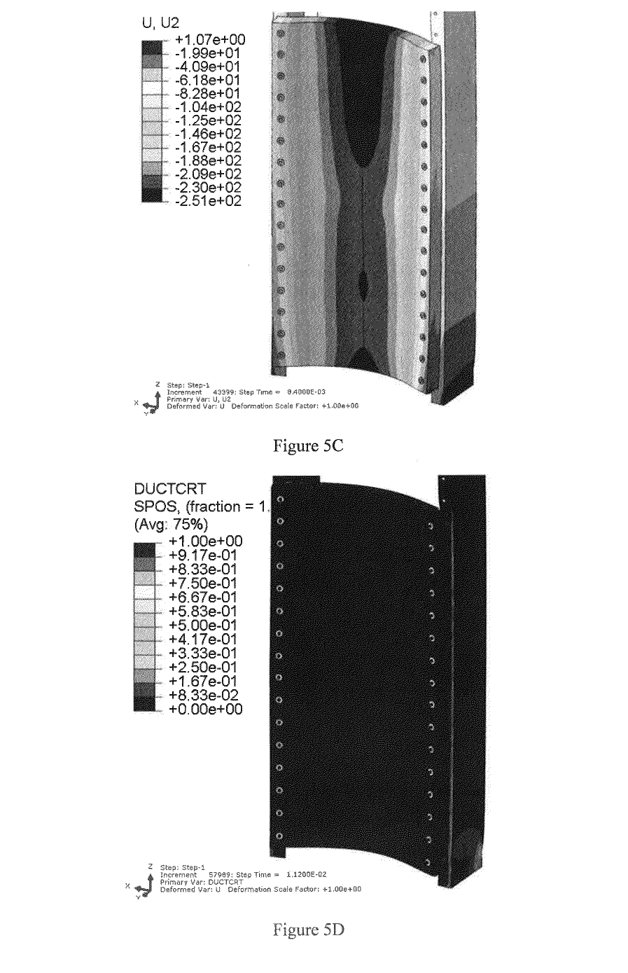

FIGS. 5A-5D show the predicted damage for a 4.5 inch (11.4 cm) nominal polycarbonate sheet laminate having one thermoplastic polyurethane layer between the each of the polycarbonate sheets using 50 lbs. (22.7 kg) of trinitrotoluene-equivalent detonated at a distance of five feet (1.52 m). FIG. 5A shows the deflection at 1.4 milliseconds, FIG. 5B at 4.2 milliseconds and FIG. 5C at 8.4 milliseconds. FIG. 5D shows the damage at 11 milliseconds. As can be appreciated by reference to FIGS. 5A-5D, the thicker panel is predicted to successfully mitigate the blast pressure, deflect inward by 250 mm but only sustains minor damage at the bolt holes.

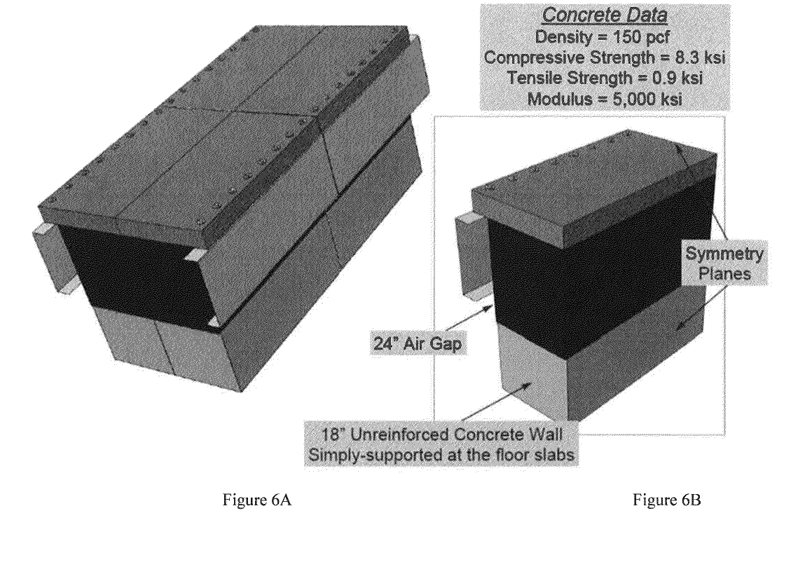

FIGS. 6A and 6B illustrate a laminate and concrete wall quarter-symmetry model. The quarter symmetry model includes a 24 inch air gap to transfer the blast pressure from the laminate to the 18 inch (0.475 m) unreinforced concrete wall.

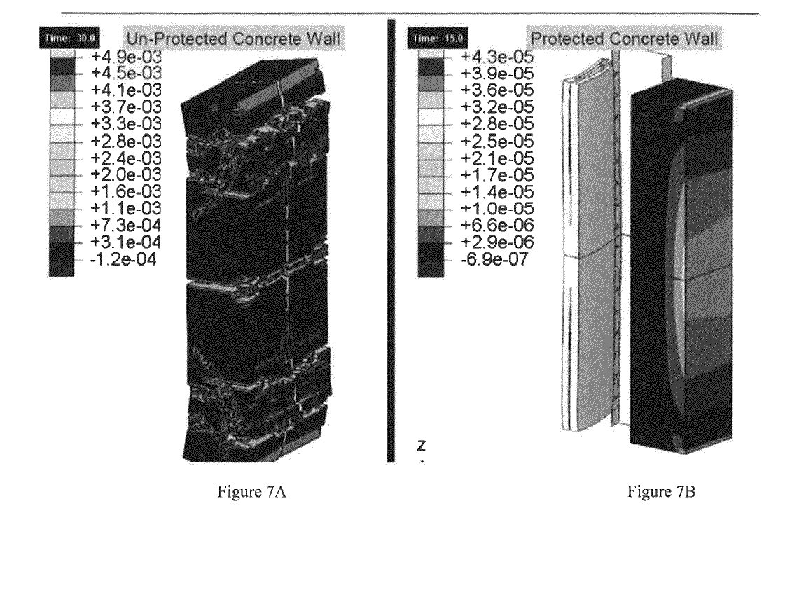

FIGS. 7A and 7B provide a comparison of subjecting an 18 inch (0.475 m) unreinforced concrete wall to a simulated 50 lbs. (22.7 kg) of trinitrotoluene-equivalent detonated at a distance of five feet (1.52 m). FIG. 7A shows an unprotected wall and FIG. 7B shows a wall protected by a three polycarbonate sheet laminate having one thermoplastic polyurethane layer between the each of the polycarbonate sheets, with a 24 inch (0.61 m) air gap. As can be appreciated by reference to FIGS. 7A and 7B, the unprotected concrete wall is predicted to crack catastrophically, whereas, the protected wall is predicted to not crack.

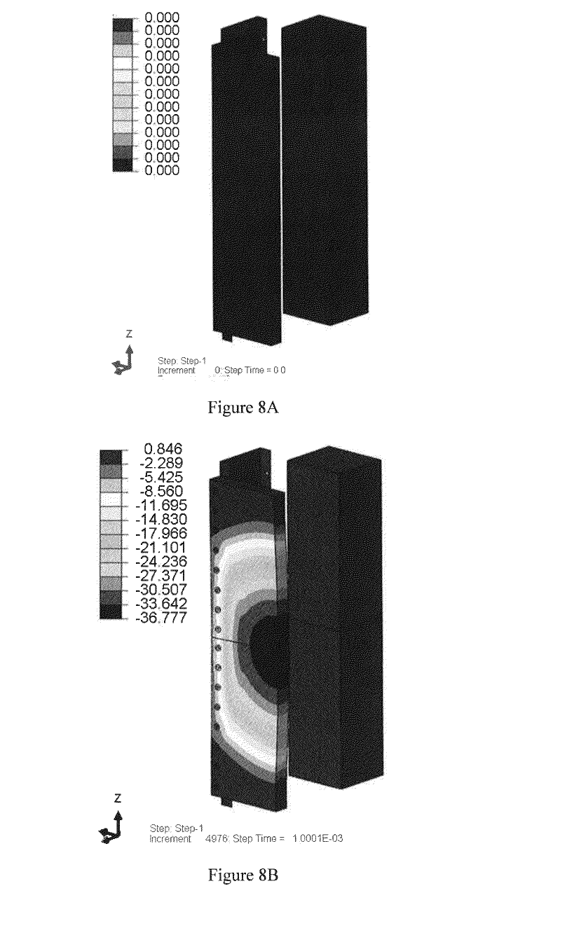

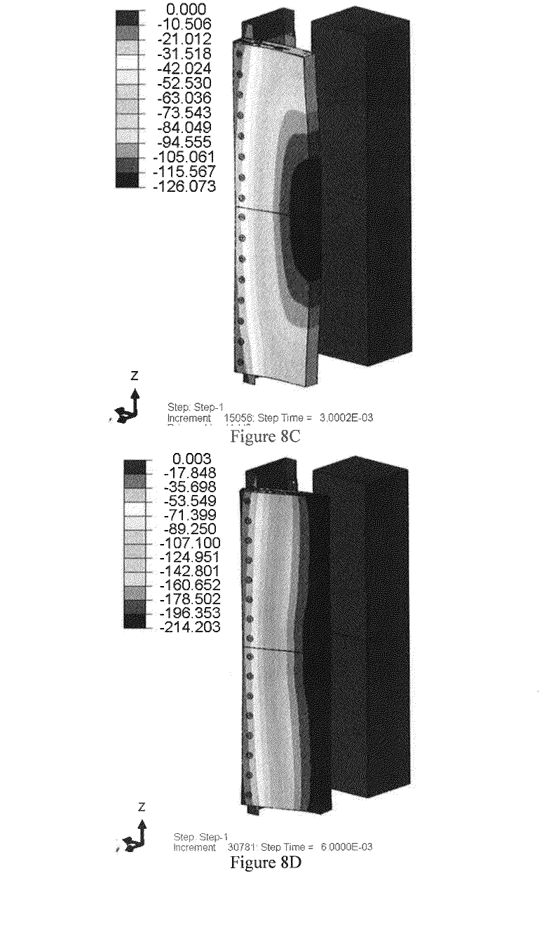

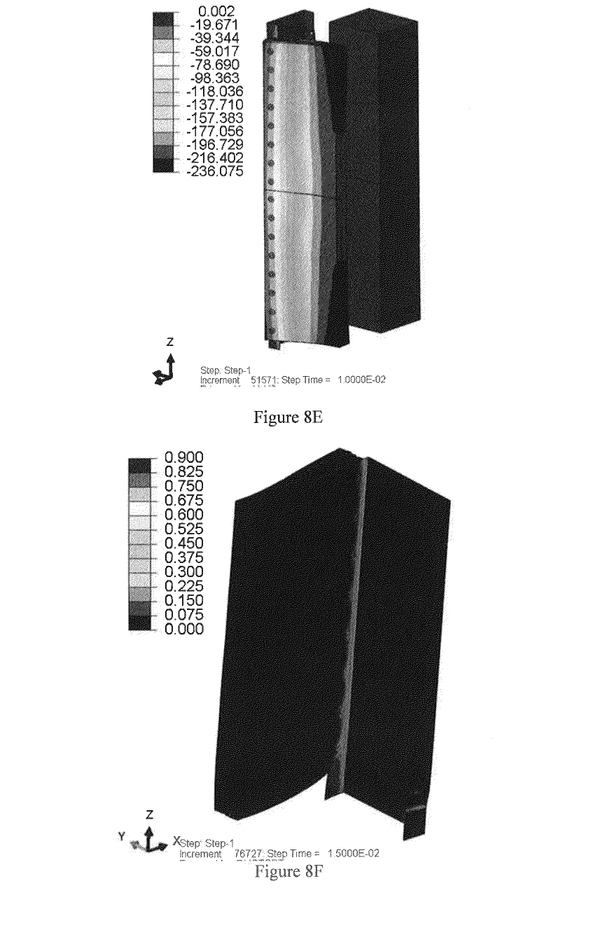

FIGS. 8A-8F illustrate the deflection prediction for the wall protected by a three polycarbonate sheet laminate having one thermoplastic polyurethane layer between the each of the polycarbonate sheets, with a 24 inch (0.61 m) air gap. FIG. 8A shows no deflection prior to the detonation. FIG. 8B shows deflection at one millisecond after detonation, FIG. 8C at three milliseconds, FIG. 8D at six milliseconds and FIG. 8E at ten milliseconds. As can be appreciated by reference to FIGS. 8A-8E, the laminate is predicted to undergo large deflection of 240 mm and only sustain minor cracking (FIG. 8F) with no failure of the I-beam.

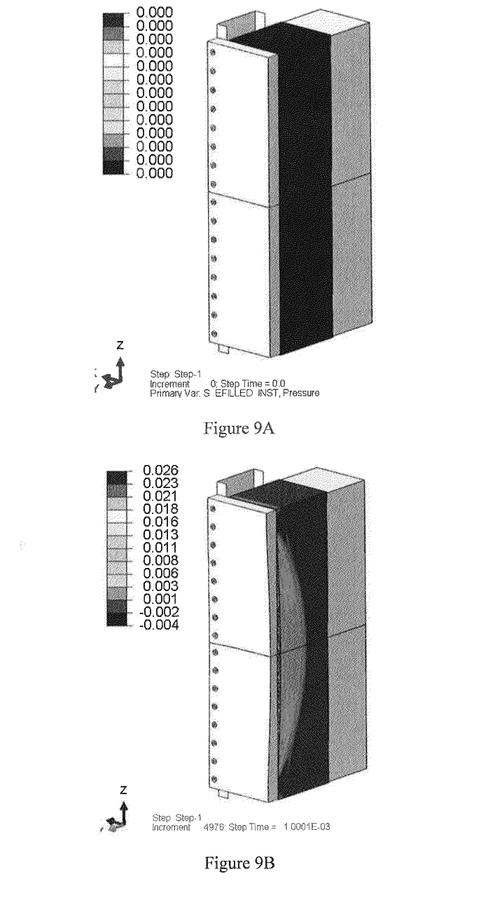

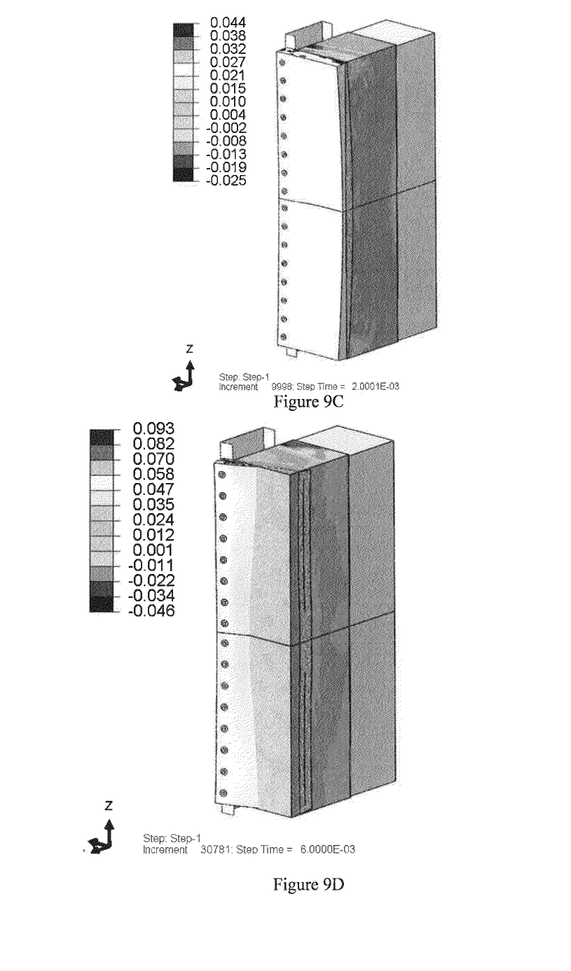

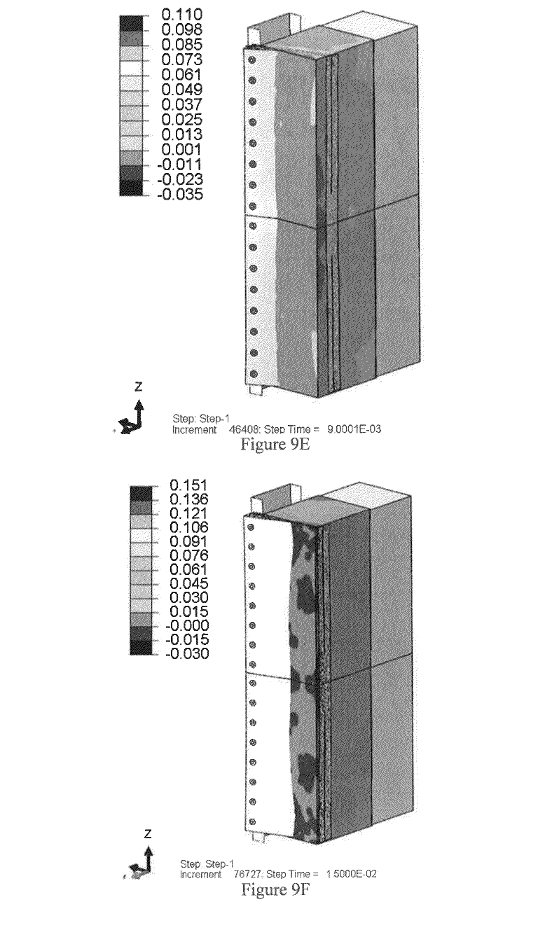

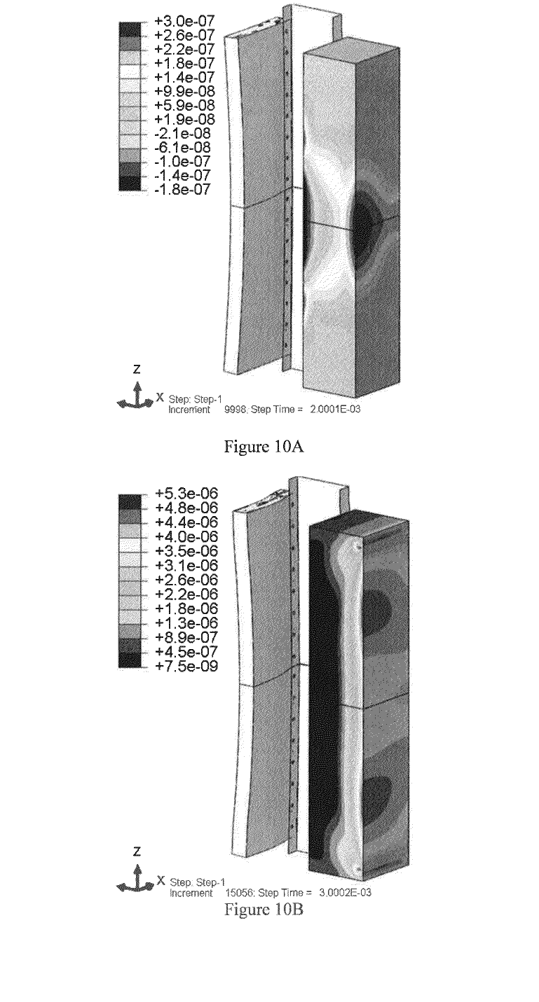

FIGS. 9A-9F illustrate the air gap pressure for a wall protected by a three polycarbonate sheet laminate having one thermoplastic polyurethane layer between the each of the polycarbonate sheets, with a 24 inch (0.61 m) air gap. FIG. 9A shows the wall and laminate prior to the detonation. FIG. 9B shows air gap pressure at one millisecond after detonation, FIG. 9C at three milliseconds, FIG. 9D at six milliseconds, FIG. 9E at nine milliseconds and FIG. 9F at 15 milliseconds after detonation. The air pressure at the interface with the concrete wall reaches a maximum value of 9 psi (62.1 kPa) shown in FIG. 9E.

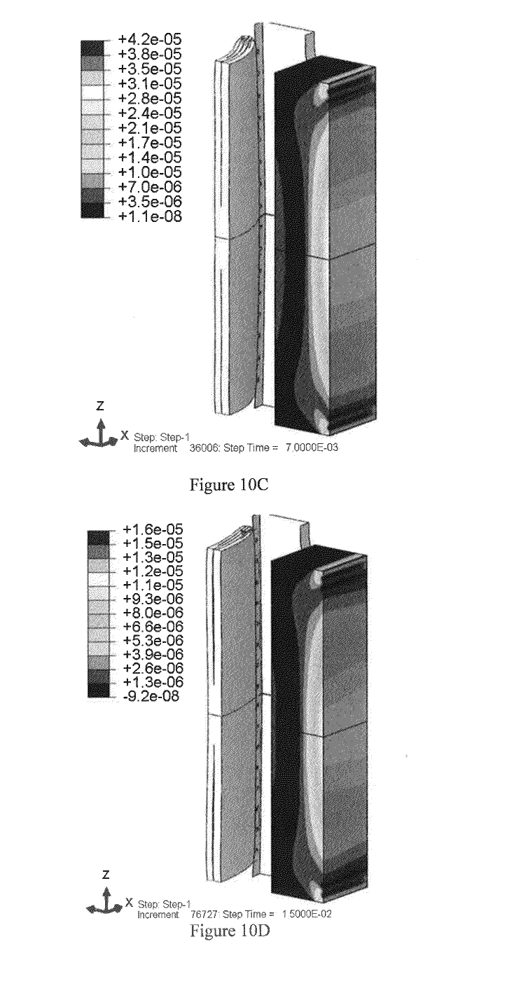

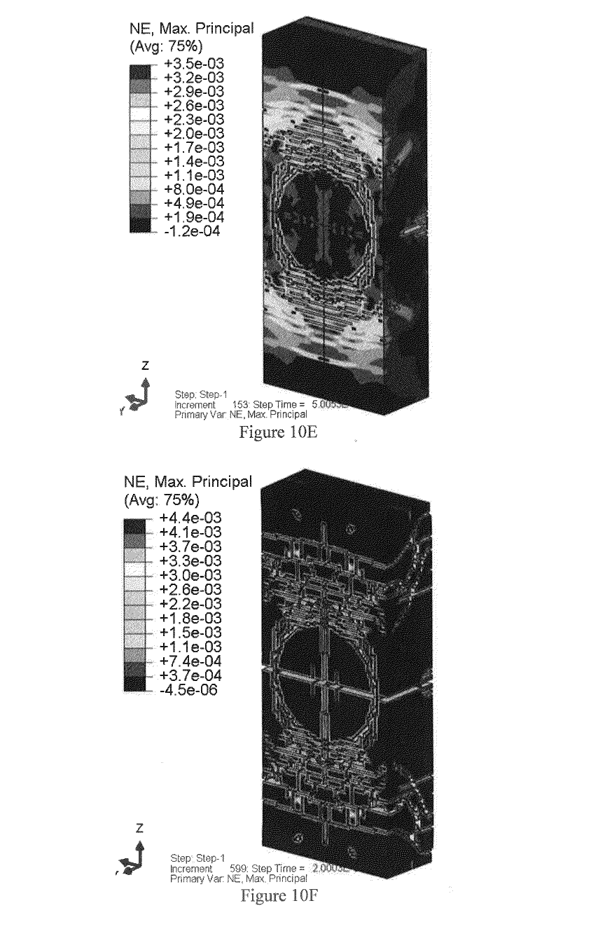

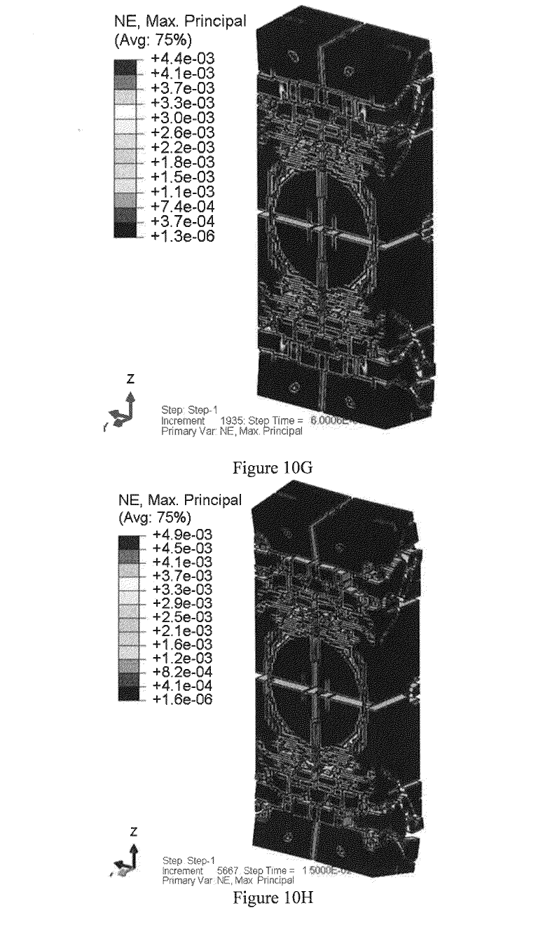

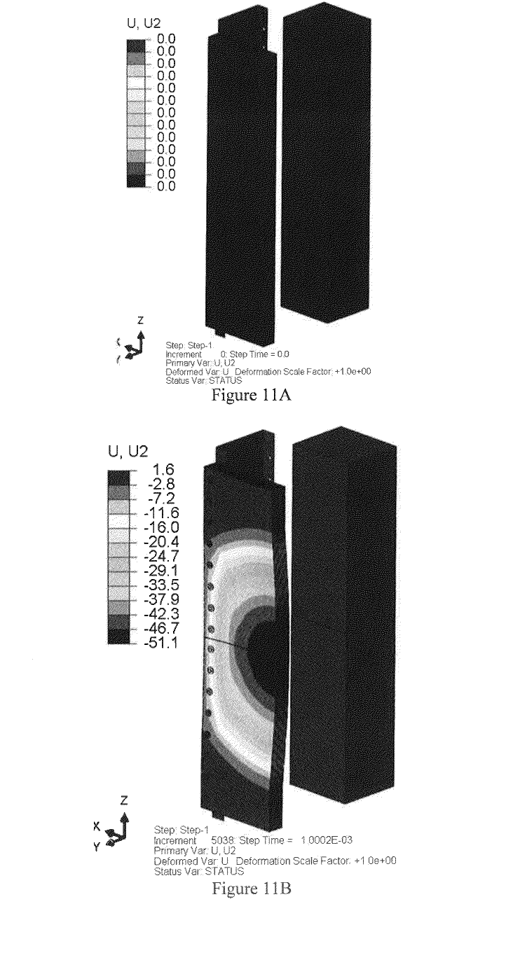

FIGS. 10A-10H illustrate the concrete wall strain for a walls that are subjected to a simulated 50 lbs. (22.7 kg) of trinitrotoluene-equivalent detonated at a distance of five feet (1.52 m). FIGS. 10A-10D show a wall protected by a three polycarbonate sheet laminate having one thermoplastic polyurethane layer between the each of the polycarbonate sheets, with a 24 inch (0.61 m) air gap with FIG. 10A at two milliseconds after detonation, FIG. 10B at three milliseconds, FIG. 10C at seven milliseconds and FIG. 10D at 15 milliseconds. Similarly, FIGS. 10E-10H show an unprotected wall exposed to the same detonation with FIG. 10E at two milliseconds after detonation, FIG. 10F at three milliseconds, FIG. 10G at seven milliseconds and FIG. 10H at 15 milliseconds. As can be appreciated by reference to FIGS. 10A-H, the strain predicted in the protected concrete wall is significantly lower by orders of magnitude compared to the unprotected concrete wall. There were no cracks in the protected concrete wall at 15 milliseconds following detonation whereas the unprotected wall is predicted to have significant damage.

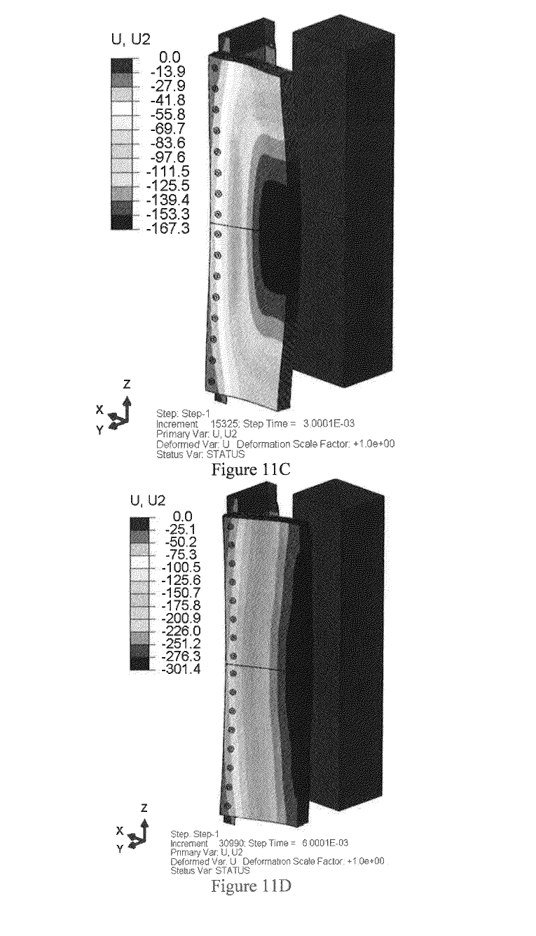

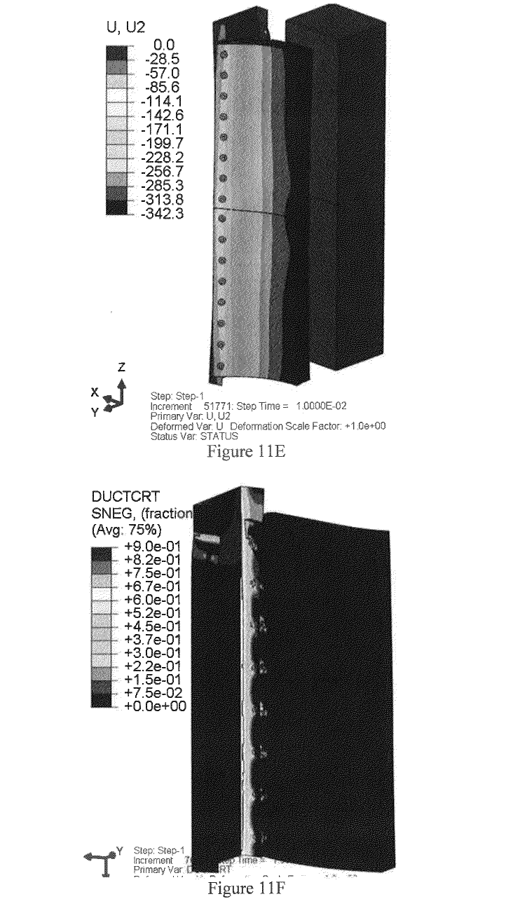

FIGS. 11A-11F illustrate subjecting an 18 inch (0.475 m) unreinforced concrete wall to a simulated 50 lbs. (223 kg) of trinitrotoluene-equivalent detonated at a distance of 4 feet (1.22 m), with the wall protected by a three polycarbonate sheet laminate having one thermoplastic polyurethane layer between the each of the polycarbonate sheets, and a 24 inch (0.61 m) air gap between the laminate and the wall. FIG. 11A shows the wall and laminate prior to the detonation. FIG. 11B shows deflection prediction at one millisecond after detonation, FIG. 11C at three milliseconds, FIG. 11D at six milliseconds and FIG. 11E at ten milliseconds. As can be appreciated by reference to FIG. 11A-E, the laminate is predicted to undergo a larger deflection of 340 mm and sustain increased cracking of the laminate and metal column. The panel and column remain intact and do not become projectiles, but are compromised (FIG. 11F) as the inner polycarbonate layer fails as does the I-beam.

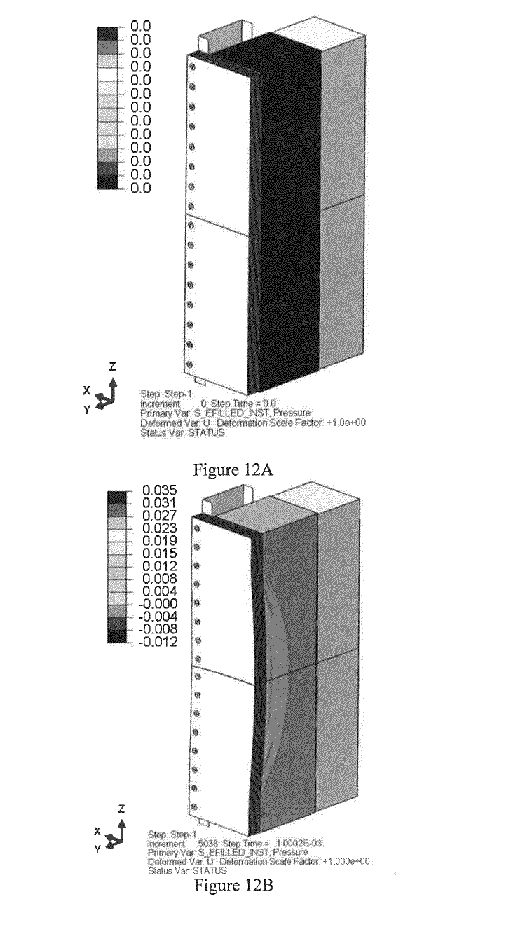

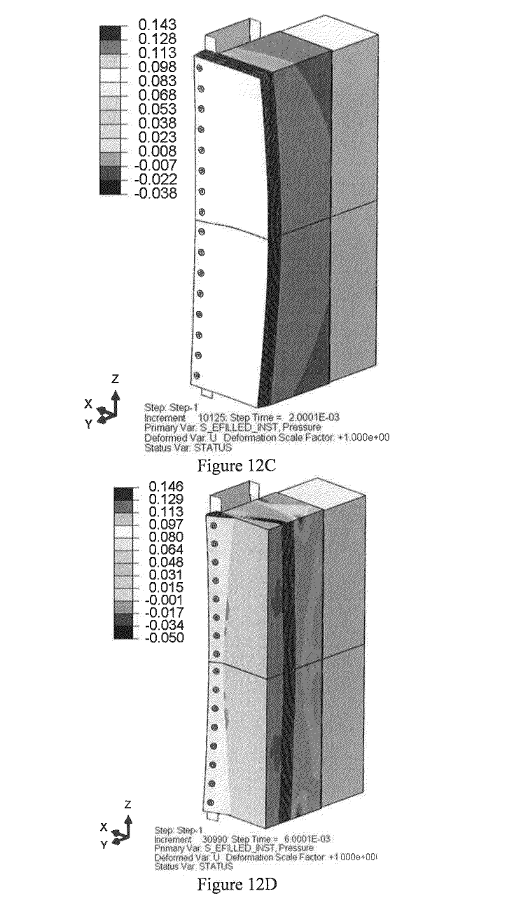

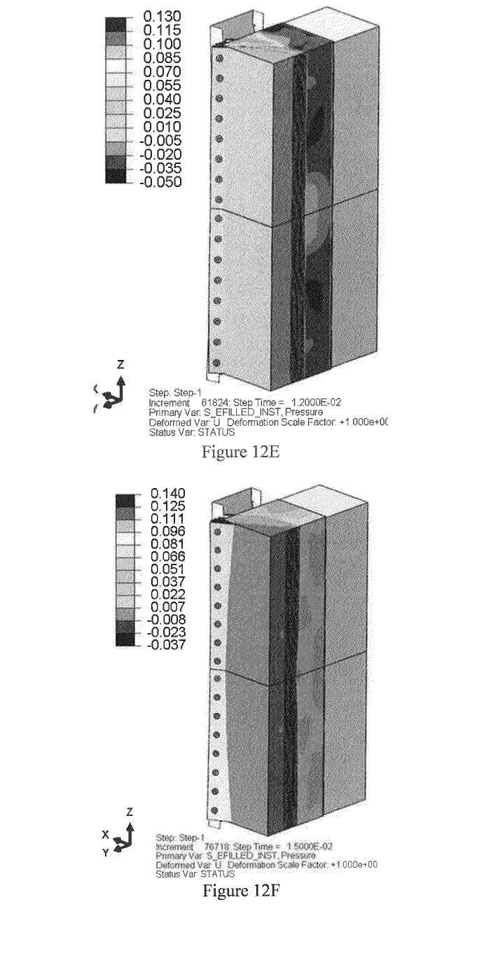

FIGS. 12A-12F illustrate the air gap pressure for the wall protected by a three polycarbonate sheet laminate having one thermoplastic polyurethane layer between the each of the polycarbonate sheets, and a 24 inch (0.61 m) air gap between the laminate and the wall. FIG. 12A shows the wall and laminate prior to the detonation. FIG. 12B shows air gap pressure at one millisecond after detonation, FIG. 12C at two milliseconds, FIG. 12D at six milliseconds, FIG. 12E at 12 milliseconds and FIG. 12F at 15 milliseconds after detonation. The air pressure at the interface with the concrete wall reaches a maximum value of 19 psi (131 kPa) shown in FIG. 12E.

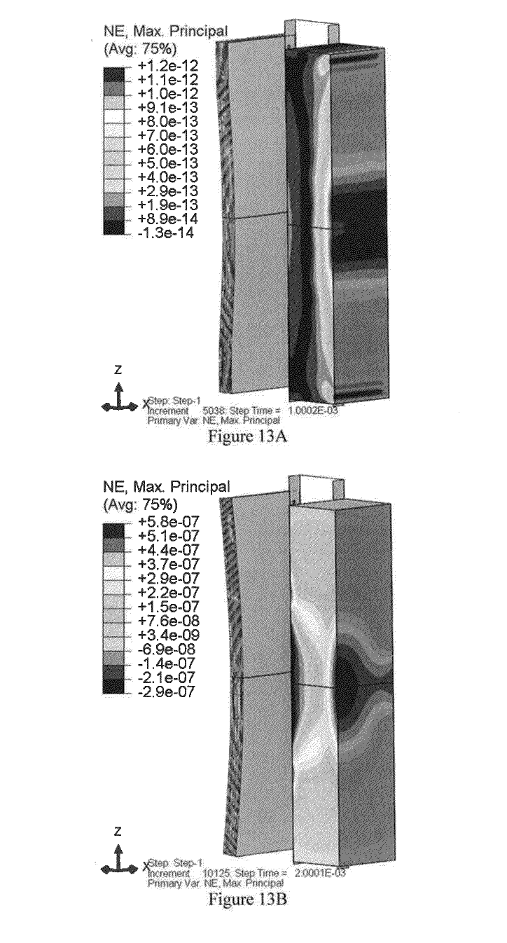

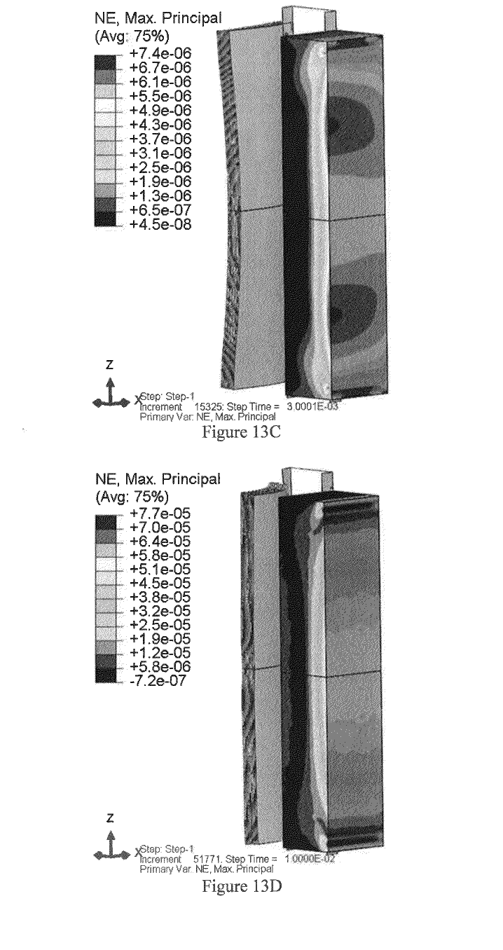

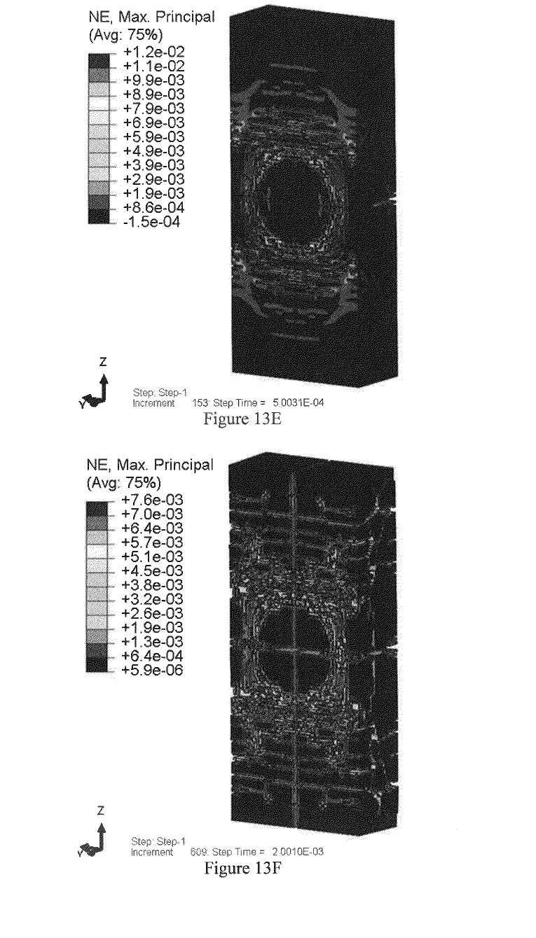

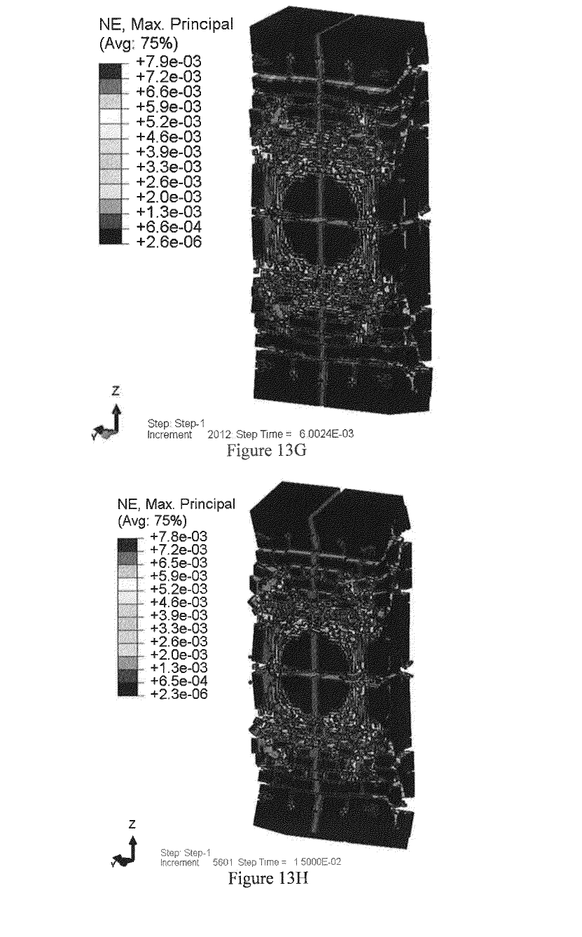

FIGS. 13A-13D illustrate the concrete wall strain for an 18 inch (0.475 m) unreinforced concrete wall that is subjected to a simulated 50 lbs. (22.7 kg) of trinitrotoluene-equivalent detonated at a distance of 4 feet (1.22 m), with the wall protected by a three polycarbonate sheet laminate having one thermoplastic polyurethane layer between the each of the polycarbonate sheets, and a 24 inch (0.61 m) air gap. Concrete wall strain for a comparable unprotected wall is shown in FIGS. 13E-13H. FIGS. 13A-13D show the wall protected by the inventive laminate with FIG. 13A at one millisecond after detonation, FIG. 13B at two milliseconds, FIG. 13C at three milliseconds and FIG. 13D at ten milliseconds. Similarly, FIGS. 13E-13H show an unprotected wall exposed to the same detonation with FIG. 13E at one millisecond after detonation, FIG. 13F at two milliseconds, FIG. 13G at three milliseconds and FIG. 13H at ten milliseconds. As can be appreciated by reference to FIGS. 13A-H, the strain predicted in the protected concrete wall is significantly lower by orders of magnitude compared to the unprotected concrete wall. There were no cracks in the protected concrete wall at ten milliseconds following detonation whereas the unprotected wall is predicted to have significant damage.

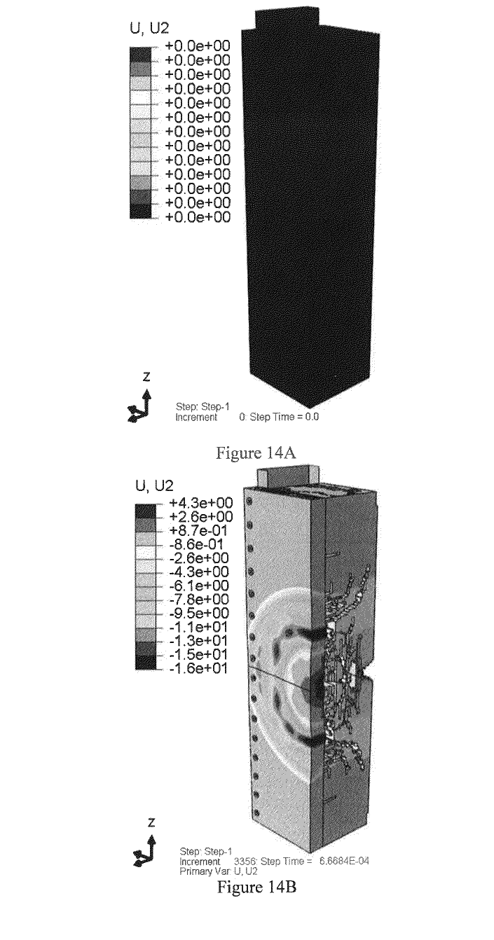

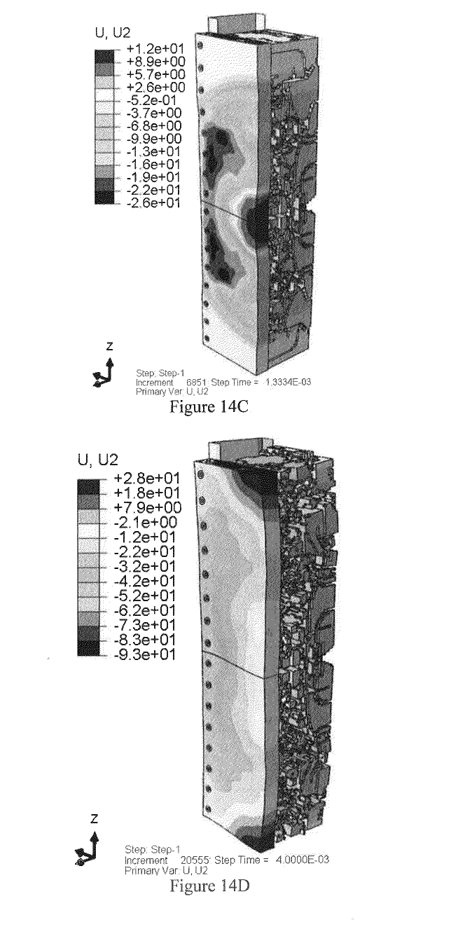

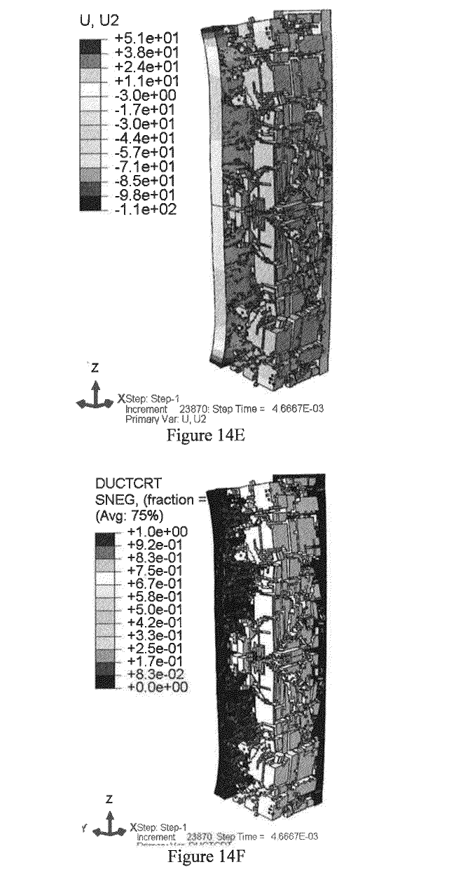

FIGS. 14A-14F show the deflection prediction of subjecting an 18 inch (0.475 m) unreinforced concrete wall to a simulated 50 lbs. (22.7 kg) of trinitrotoluene-equivalent detonated at a distance of three feet (0.914 m), with the wall protected by a three polycarbonate sheet laminate having one thermoplastic polyurethane layer between the each of the polycarbonate sheets and no air gap. FIG. 14A shows no deflection prior to the detonation. FIG. 14B shows deflection at 0.7 milliseconds after detonation, FIG. 14C at 1.3 milliseconds and FIG. 14D at four milliseconds. As can be appreciated by reference to FIGS. 14E and 14F, in the absence of an air gap, the inventive laminate is not able to absorb as much blast energy and is therefore predicted to not be an effective solution.

The results of these examples are summarized below in Table 1. As can be appreciated by reference to Table 1, the laminate is predicted to be effective against a 50 lbs. (22.7 kg) charge of trinitrotoluene-equivalent as close as 4 feet (1.22 m) before significant damage is seen in the concrete wall. Additional studies (data not reported here) have shown the laminate to be effective against 100 lbs. (45.4 kg) of trinitrotoluene-equivalent from 5 feet (1.52 m).

TABLE I

| | TNT equivalent | Standoff | Pressure | td | Laminate | Laminate |
|---|---|---|---|---|---|---|
| Ex. | mass lbs. (kg) | ft. (m) | psi (MPa) | (msec) | with air gap | without air gap |
| 1 | 50 (22.7) | 2 (0.61) | 24062 (166) | 0.32 | Flange/bolt | |
| | | | | | tear out | |
| 2 | 50 (22.7) | 3 (0.914) | 12425 (85.7) | 0.31 | Beam flange | Laminate pass |
| | | | | | failure | concrete wall fail |
| 3 | 50 (22.7) | 4 (1.22) | 7546 (52) | 0.32 | Hole failure | Laminate pass/ |
| | | | | | inner PC/ | concrete wall fail |
| | | | | | concrete wall | |
| | | | | | pass | |
| 4 | 50 (22.7) | 5 (1.52) | 4964 (34.2) | 0.35 | Laminate | Laminate pass/ |
| | | | | | pass/concrete | concrete wall fail |
| | | | | | wall pass | |

The present inventors contemplate that the laminate of the present invention is well suited for providing protection from close-proximity blast, ballistic events and severe storm events, such as hurricanes, cyclones, typhoons and tornados.

The foregoing examples of the present invention are offered for the purpose of illustration and not limitation. It will be apparent to those skilled in the art that the embodiments described herein may be modified or revised in various ways without departing from the spirit and scope of the invention. The scope of the invention is to be measured by the appended claims.

What is claimed is:

1. A laminate for protecting an object against one of a close-proximity blast, a ballistic event and a severe storm event, the laminate comprising two or more layers of polycarbonate having layered therebetween one or more layers of a thermoplastic polyurethane.

2. The laminate according to claim 1, wherein the polycarbonate is in the form of sheets.

3. The laminate according to one of claims 1 and 2, wherein the thermoplastic polyurethane is in the form of film.

4. The laminate according to one of claims 1 to 3, wherein the laminate is at a standoff from about 2 feet (0.61 m) to about 4 feet (1.22 m) from the object.

5. The laminate according to one of claims 1 to 4, wherein the laminate is about 4 inches (10.2 cm) to about 6 inches (15.2 cm) in thickness.

6. The laminate according to claim 5, wherein the laminate is about 4 inches (10.2 cm) to about 5 inches (12.7 cm) in thickness.

7. The laminate according to claim 1, wherein the severe storm event is one selected from the group consisting of hurricane, cyclone, typhoon and tornado.

8. A protective system for one of a close-proximity blast, a ballistic event and a severe storm event, the system comprising a laminate comprising two or more layers of polycarbonate having layered therebetween one or more layers of a thermoplastic polyurethane.

9. The protective system according to claim 8, wherein the polycarbonate is in the form of sheets.

10. The protective system according to one of claims 8 and 9, wherein the thermoplastic polyurethane is in the form of film.

11. The protective system according to one of claims 8 to 10, wherein the laminate is at a standoff from about 2 feet (0.61 m) to about 4 feet (1.22 m) from an object to be protected.

12. The protective system according to one of claims 8 to 11, wherein the laminate is about 4 inches (10.2 cm) to about 6 inches (15.2 cm) in thickness.

13. The protective system according to claim 12, wherein the laminate is about 4 inches (10.2 cm) to about 5 inches (12.7 cm) in thickness.

14. The protective system according to claim 8, wherein the severe storm event is one selected from the group consisting of hurricane, cyclone, typhoon and tornado.

15. A method for protecting an object from one of a close-proximity blast, a ballistic event and a severe storm event, the method comprising placing between the object and the blast, ballistic and storm event, a laminate comprising two or more layers of polycarbonate having layered therebetween one or more layers of a thermoplastic polyurethane.

16. The method according to claim 15, wherein the polycarbonate is in the form of sheets.

17. The method according to one of claims 15 and 16, wherein the thermoplastic polyurethane is in the form of film.

18. The method according to one of claims 15 to 17, wherein the laminate is about 4 inches (10.2 cm) to about 6 inches (15.2 cm) in thickness.

19. The method according to one of claims 15 to 18, wherein the laminate is about 4 inches (10.2 cm) to about 5 inches (12.7 cm) in thickness.

20. The method according to claim 15, wherein the severe storm event is one selected from the group consisting of hurricane, cyclone, typhoon and tornado.

21. The method according to one of claims 15 to 20, wherein the laminate is placed at a standoff of about 2 feet (0.61 m) to about 4 feet (1.22 m) from the object.

22. A method of protecting an object against about 50 lbs. (22.7 kg) to about 100 lbs. (45.4 kg) of trinitrotoluene-equivalent detonated at a distance of about 3 feet (0.914 m), the method comprising placing between the object and the about 50 lbs. to about 100 lbs. of trinitrotoluene-equivalent, a laminate comprising two or more layers of polycarbonate having layered therebetween one or more layers of a thermoplastic polyurethane.
